(19) United States
(12) Patent Application Publication
(10) Pub. No.: US 2004/0066042 A1
(43) Pub. Date: Apr. 8, 2004

(54) Power generation device based on rotational motion derived from gravitational pull

(76) Inventor: M. Blair Pessemier, Seattle, WA (US)

Correspondence Address: M. Blair Pessemier, 9210 34th Avenue SW, Seattle, WA, 98126, US

(21) Appl. No.: 10/265,471

(22) Filed: Oct. 7, 2002

(51) Int. Cl. H02P 9/04

(52) U.S. Cl. 290/1 R

(57) ABSTRACT

A power generation device for providing uninterrupted power is disclosed. The power supply device consists of two equal inversely oriented eccentric load flywheels interlockingly rotating in-line on a common horizontal shaft (where surface friction is minimized at all connections) within a housing.

### REFERENCES CITED [REFERENCED BY]

### U.S. Patent Documents

U.S. Pat. No. 6,282,502 August, 2001 Sundaresan et al. 703/1

U.S. Pat. No. 6,137,187 October, b 2000 Mikhail et al. 290/44

U.S. Pat. No. 5,967,933 October, 1999 Valdenaire 475/255

U.S. Pat. No. 5,485,761 January, 1996 Rouverol 74/462

U.S. Pat. No. 4,928,486 May, 1990 Despres 60/338

U.S. Pat. No. 1,525,642 February, 1925 Cox 74/462

### FIELD OF THE INVENTION

This invention relates to deriving uninterrupted rotational motion from gravitational pull, sufficient to generate power supply.

### BACKGROUND OF THE INVENTION

For centuries, man has tried to harness in some way the effects of gravity to produce mechanical energy.

Devices produced have been labeled perpetual motion machines, and have been the joke of many a scientist. This device relies on two properties 1—that if equal weights are placed an equal distance from a central shaft that the shaft would spin freely except for the friction of bearing (or turning) and 2—that a weight placed a greater distance from a fulcrum point will proportionally lift the greater weight by the relation of the distances from the fulcrum.

Recent advances have given us new lightweight high tensile products and new low friction coatings and materials. When the energy derived by gravity exceeds the friction of the device, mechanical energy will be produced.

Energy demands for point generation of power in remote areas, non-polluting power generation and power generation non-susceptible to interruption of supply make this device a small but important resource for the future.

### SUMMARY OF THE INVENTION

In accord with the present invention, an uninterruptable power supply device is comprised of two equal flywheels whose majority of weight is an exterior point load, that are inversely interconnected (that is to say that they are connected in a fashion where the point load of the first flywheel is closest to the center of the main horizontal turning shaft when the point load of the second flywheel is furthest from the center of the main horizontal shaft).

The support structure(s) of the two flywheels is connected to the main horizontal turning shaft(s). The flywheels and the main turning shaft(s) rotate in-line.

The flywheels are designed to rotate with the least practical friction. The flywheels and supporting structure turn within a vacuum housing. Composite fiber materials are utilized for the support structure and for the flywheels (except for the exterior point load of each flywheel). The majority of weight of turning is in the point load of each equal flywheel.

This power generation device's system balance is assured by continuous adjusted alignment to gravitational horizontal and damping vibration and shaft torque for steady rotational speed.

### BRIEF DESCRIPTION OF THE DRAWINGS

FIG. 1 is an elevation view, in partial cross-section, of the two flywheels, interconnected and turning in-line on a common horizontal shaft(s).

FIG. 2 is a cross section plan view.

FIG. 3 is a simplified horizontal balancing system.

FIG. 4 is a view of a damping system for the main shaft(s).

### DETAILED DESCRIPTION OF THE INVENTION INCLUDING PREFERRED EMBODIMENTS

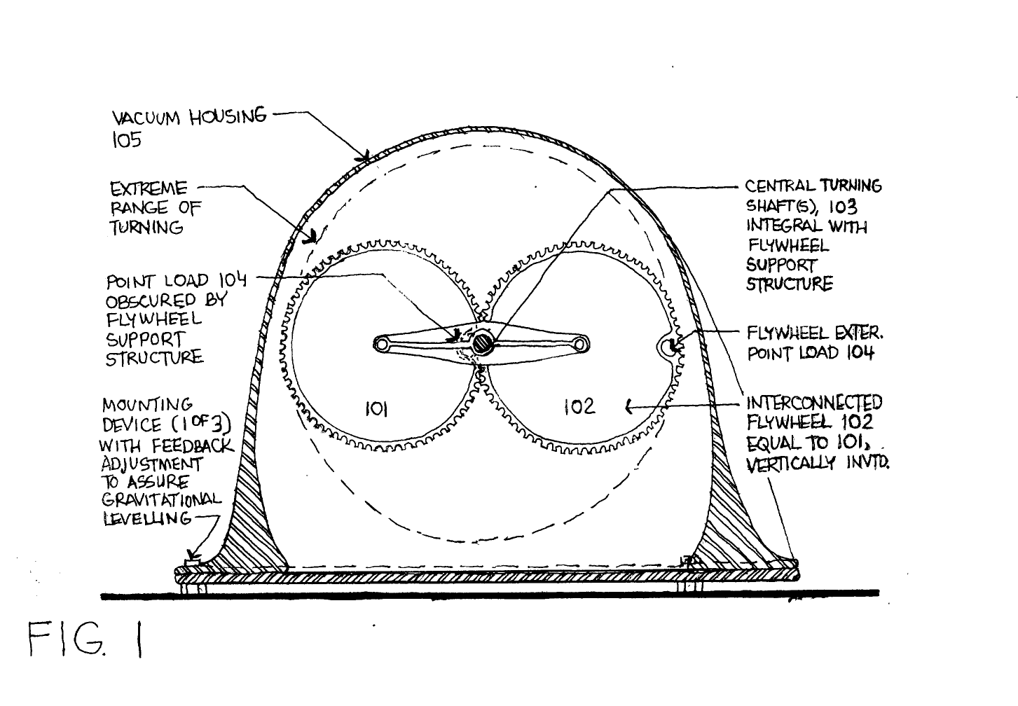

A preferred power generating device in accord with the present invention will be described with reference to the drawings. FIG. 1 illustrates the relation of the two off-balanced exterior load flywheels with respect to each other and to the central horizontal turning shaft(s). Each flywheel has the majority of its weight in a point load furthest from their center. The flywheels are connected where the point load of the first flywheel 101 is closest to the center of the main horizontal turning shaft when the point load of the second flywheel 102 is furthest from the center of the main horizontal shaft. The flywheels and their supporting structure (including the central shaft(s)) turn within a vacuum housing.

The flywheels by their interconnection are forced to turn in opposite directions. The friction of turning the two flywheels needs to be less than friction of their interconnection. The friction of turning the main shaft needs to exceed the combined total of the friction of interconnection and the friction of turning of the two flywheels, to create the eccentric loading to make the turning shaft to act as a fulcrum point.

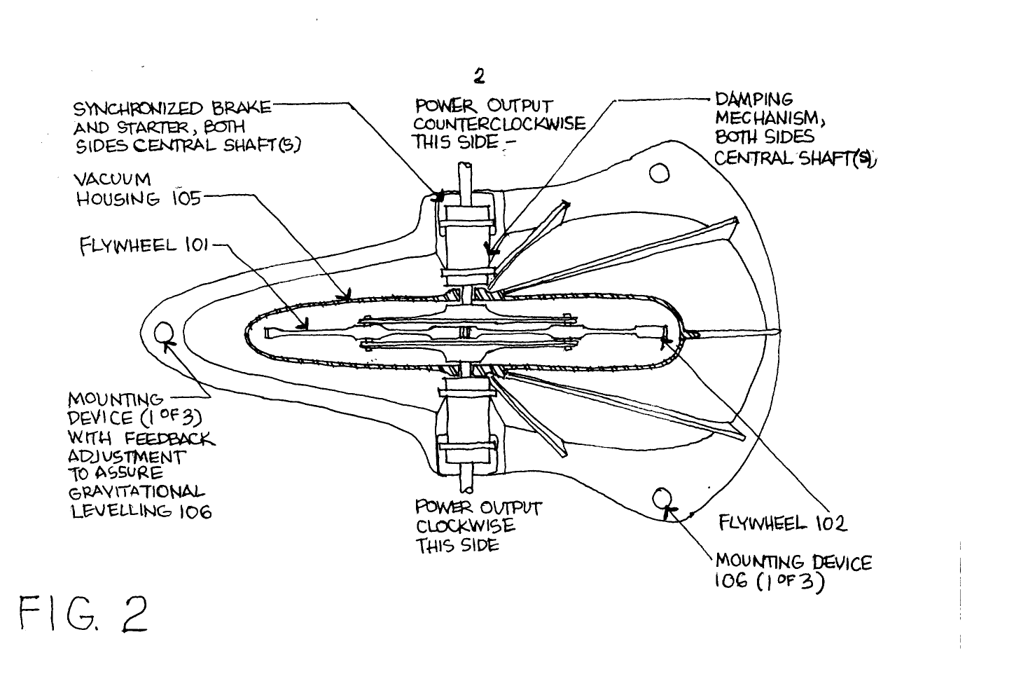

Lowest friction connections combined with the lightest composite high-tensile materials preferably carbon or glass fibers in an epoxy matrix will maximize the power generation potential of this device. FIG. 2 illustrates with a cross section plan view the support structure for the two flywheels and the central horizontal turning shaft(s). The point load of these equal flywheels needs to be located at furthest practical point from the center of each flywheel.

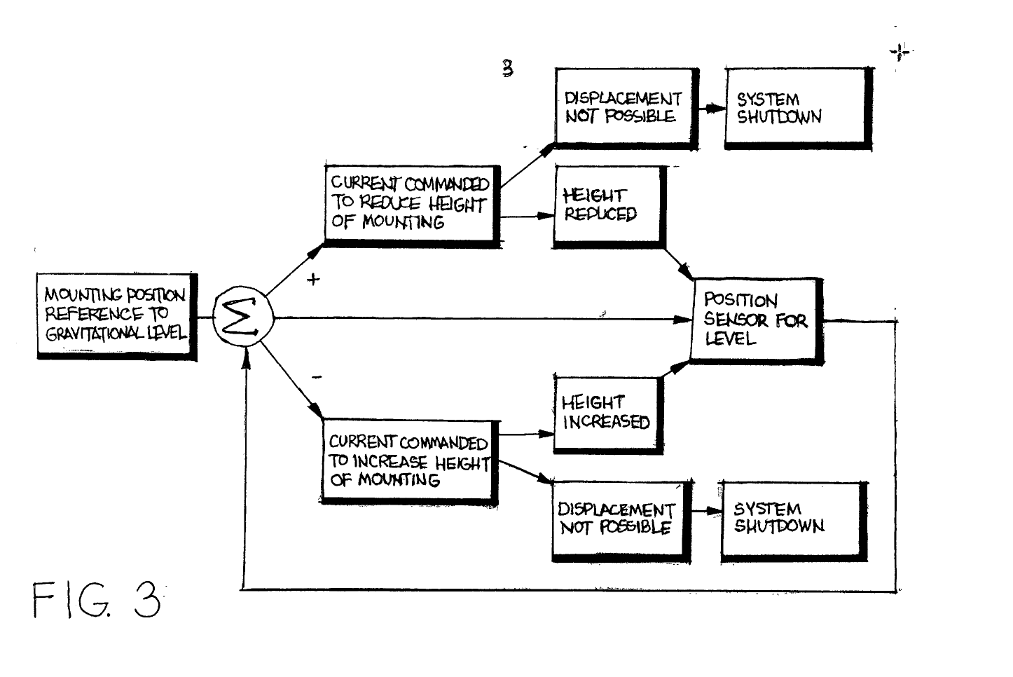

Continuous adjusted alignment of this power generation device is necessary to insure the shaft remains horizontal to gravity to insure system balance. The preferred embodiment would include computer monitored leveling which would continuously raise or lower of one of three support points based on sensing of gravitational horizontal. FIG. 3 illustrates a simplified horizontal balancing function. If we give each mounting point a letter a, b or c; then if the line between b and c is level when the line between a and b and the line between a and c is not level then a will be raised or lowered as necessary until the two are level. This similarly applies to the line between a and c (for raising or lowering b to reach level, or for the line between a and b (for raising or lowering c to attain system horizontal).

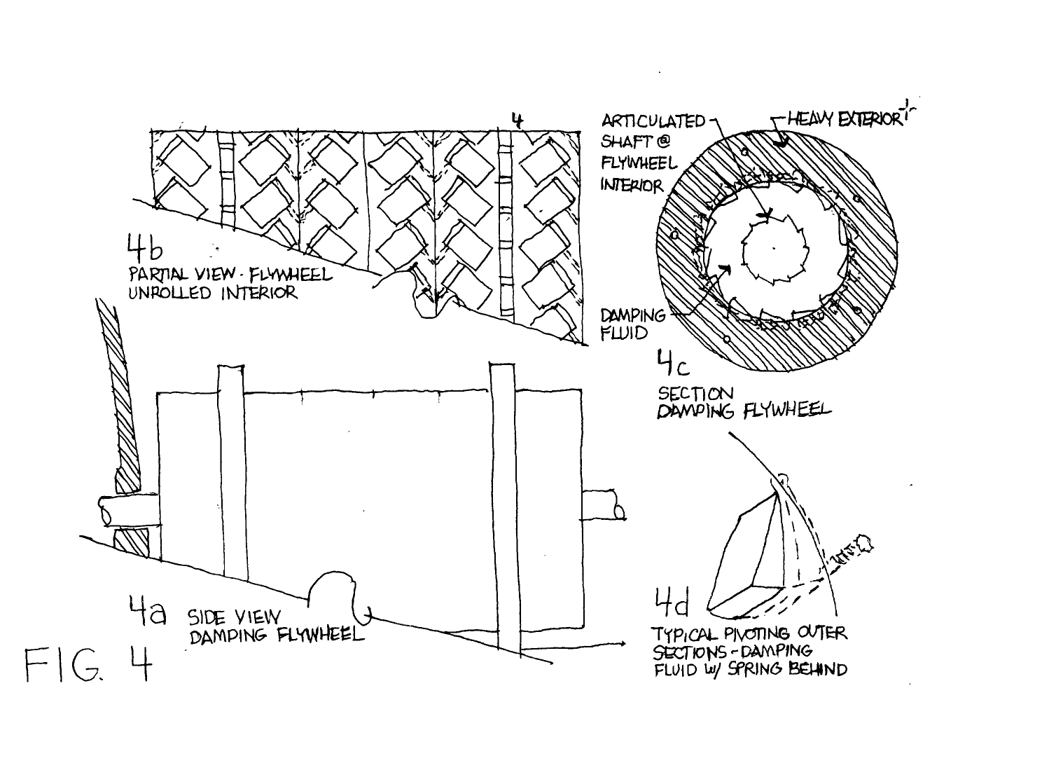

A damping system is preferably comprised (see FIG. 4) of two different functions. The first is to damp radial vibrations. The second function is to damp the overall speed of turning, to modulate variations to provide steady rotational speed. The proposed damping system would preferably utilize a series of pivoting sections backed with a more durable damping fluid and a sprue with a spring in the heavy outer ring and separated from the articulated turning shaft (in this flywheel area only) by a damping fluid. The heavy outer flywheel would be free turning yet fixed in location to the outer casing of the vacuum housing.

This power device system preferably should embody an element that can act as a starter, by moving the central shaft(s) to begin the turning, and a shaft brakes for the central horizontal turning that can hold the system at rest, and provide and overspeed shutdown system if the power generation device exceeds 110% of its rated value.

This invention has been described in detail with reference to preferred embodiments thereof. However, it would be appreciated that, upon consideration of the present specification and drawings, those skilled in the art may make modifications and improvements within the spirit and scope of this invention as defined by the claims.

I claim:

1. A power supply device providing uninterrupted power, the power supply device comprising two equal eccentric inversely interconnected exterior point load flywheels rotating in-line along a common horizontal shaft.

2. The power supply device of claim 1, wherein the housing contains a vacuum.

3. The power supply device of claim 1, where the flywheels utilize radial touchdown bearings with a ring of polyimide material.

4. The power supply device of claim 1, where the flywheel and frame components are comprised of glass, carbon or composite fibers in an epoxy matrix (excepting the eccentric point flywheel load).

5. The power supply device of claim 1, where continuous adjusted alignment to gravitational horizontal is made to assure system balance.

6. A flywheel device, where for each of the two equal eccentric load flywheels has the majority of turning weight at an exterior point of each flywheel.

7. A flywheel support structure which is integral to the horizontal turning shaft(s) consisting of composite fibers in an epoxy matrix.

8. A horizontal shaft(s), where a damping mechanism is utilized at both shaft ends to modulate variations in shaft torque for steady rotational speed.

9. A coefficient of friction, where the flywheel interconnection is more than the sum of the friction of rotation of the two flywheels, and where, the friction of turning of the main shaft exceeds the friction of both the flywheel rotations and their connection.
